(19) United States
(12) Patent Application Publication
(10) Pub. No.: US 2003/0159250 A1
(43) Pub. Date: Aug. 28, 2003

(54) Releasably attachable grip

(76) Inventor: Bruce M. Ruana, Gardnerville, NV (US)

Correspondence Address: Kristin C. Castle, Sierra Patent Group, P.O. Box 6149, Stateline, NV, 89449, US

(21) Appl. No.: 09/874,940

(22) Filed: Jun. 4, 2001

(51) Int. Cl. E05B 1/00

(52) U.S. Cl. 16/431

(57) ABSTRACT

A device, method and system for a secure, comfortable grip on a railing or other hand support system. The device includes a skin layer permanently adhered to a 4-way stretchable material layer. The 4-way stretchable material layer is releasably adhered to a railing or other hand support system. A backing layer between the skin layer and the 4-way stretchable material layer can be inserted for greater comfort and friction. The grip of the present invention is designed to be releasably attachable to the railing or other hand support system.

### BACKGROUND

1. Field

The present invention relates to grips for hand railings or other hand support systems. More specifically, the present invention relates to grips which are releasably adhered to railings or other hand support systems.

2. Prior Art

Hand railings are in use throughout the world to assist in human activity such as standing, sitting down, ascending and descending a stairway, entering or exiting a moving vehicle, walking, etc. Maintaining a secure, comfortable grip is extremely important when operating or using various hand-held apparatuses or, more importantly, simply for safety purposes when grasping any type of railing. Bare railings are used for hand supports by users, standing, or sitting, or while entering or exiting a vehicle. Bare railings, whether they are constructed from any type of metal, plastic, wood, glass, concrete or composite material can be slippery, or coarse and inconvenient to hold onto with bare hands. Furthermore, uncovered railings located in moving vehicles such as subway train cars, light rail transit cars, transit buses, trams, street cars, trolley cars, recreational vehicles, etc., are unsafe when the vehicle is in motion and especially when turning. Typically, such railings are extruded shapes, such as a circular tube or another similar shape made for the human hand to grasp. Additionally, these railings are usually constructed from durable metal, such as stainless steel, but may also be constructed from wood or various other substances.

Such typical hand railings, however, do not provide a positive gripping surface, which would still further assist in the corresponding human activity associated with the hand railing. Some of the present gripping devices include molded plastic cylindrical grips which are installed and include cross-sectional sections designed to fit the human hand as in U.S. Pat. No. 5,584,096 to Auroura, rigid hand railings having a plurality of finger sized indentations, U.S. Pat. No. 5,190,267 to Schmitt, et al. and rail covering systems for outdoor decks as in U.S. Pat. No. 6,062,519 to Baldassarre. Still other gripping devices include removable foam grips that are wrapped around a bar each time a user wishes to use a bar as in U.S. Pat. No. 5,775,756 to Rozenich. This type of grip is typically used for weightlifting equipment. The grips to date involve either railings with built in grips or grips that are, for the most part, permanently attached to the railings, while other grips are not attached at all, rather they are easily removed and transferred from bar to bar.

To date, no grips have been designed which will conform to any railing surface or shape and which are releasably attachable to such railing surface. Hence, there is a need for a grip which will conform to any railing type and which will attach to any railing surface regardless of the type of surface or type of material used as the grip and a grip which is releasably attachable to the railing.

### SUMMARY OF THE INVENTION

The present invention is a method, system and device for providing a secure, resilient gripping surface on a railing or other hand support system. The grip of the present invention is designed to provide a secure, resilient gripping surface on any railing or hand support system surface that is grasped by a hand. The grip is preferably utilized on a railing or other hand support system. However, it is readily apparent that the grip could also be used on other structures, such as support poles and beams, etc.

In one aspect of the present invention, a flexible gripping pad is provided which is easily secured to a railing or hand support system by wrapping the grip around the railing or hand support system. The grip may fully cover the railing, or it may be artfully wrapped or it may be partially or fully folded. The grip of this invention will provide a comfortable, resilient gripping surface which will enhance the safety of a railing or hand support system by preventing slipping, hand abrasions or other dangers associated with railings or hand support systems.

In one aspect, the grip of the present invention comprises a skin layer having a top surface and a bottom surface, and a 4-way stretchable material layer having a top surface and a bottom surface. The top surface of the 4-way stretchable material layer is permanently adhered to the bottom surface of the skin layer. The bottom surface of the 4-way stretchable material layer is releasably attached to the railing or hand support system.

The skin layer may be formed from any material which will provide a safe and secure gripping surface. Some examples of possible skin materials include expanded vinyl, which is vinyl with a layer of foam that imparts a soft, textured feel, leather, plastic sheeting, plastic roll stock, any type of foam product, polyurethane, urethane, woven fabrics, rubber material and foil material. If a vinyl material is used, the vinyl may be supported or unsupported. Similarly, the 4-way stretchable material may comprise any material that can be simultaneously stretched in four directions, such as mylar.

In yet another aspect of the present invention, the skin layer of the grip of the present invention has a luminescent quality. The luminescent skin layer glows in the dark to provide additional safety in cases of an emergency.

In another embodiment, the grip of the present invention comprises a skin layer having a top surface and a bottom surface, and a backing layer having a top surface and a bottom surface. The top surface of the backing layer is permanently adhered to the bottom surface of the skin layer. Furthermore, the backing layer is permanently attached to a 4way stretchable material layer with a stretchable top surface and a stretchable bottom surface. The bottom surface of the 4-way stretchable material layer is releasably attached to the railing or hand support system.

The grip of the present invention may have tapered edges on its lengthwise sides so that when the grip is spirally wrapped around a railing or other hand support system and the edges overlap, the thickness of the grip remains constant. As an alternative to wrapping the grip such that the edges overlap, the grip may be wrapped so that the edges do not overlap, thus providing additional friction for the user.

One method of manufacturing the grip of the present invention comprises providing a skin layer which has a top surface for gripping and a bottom surface to which a permanent adhesive applied. Next, a 4-way stretchable material that has a top surface and a bottom surface is permanently attached to the bottom surface of the skin layer. Finally, the bottom surface of the 4-way stretchable material is releasably adhered to the railing.

Another method of manufacturing the grip of the present invention comprises providing a skin layer which has a top surface for gripping and a bottom surface to which a permanent adhesive is applied. Next, a backing layer is provided, which has a top surface and a bottom surface. The top surface of the backing layer is adhered to the bottom surface of the skin layer. Next, a 4-way stretchable material layer with a top surface and a bottom surface is permanently attached to the backing layer by adhering the backing layer bottom surface to the 4-way stretchable layer top surface. Finally, the 4-way stretchable material is releasably adhered to the railing.

The system of the present invention is designed for providing a secure, safe, releasably attachable grip on a railing. The system comprises a grip having a 4-way stretchable layer with an inner surface and an outer surface and a skin layer with an inner surface and an outer surface, the inner surface of the skin layer is adhered to the outer surface of the 4-way stretchable layer. The inner surface of the 4-way stretchable layer is releasably adhered to the railing.

Another system of the present invention is also designed for providing a secure, safe, releasably attachable grip on a railing. The system comprises a grip having a backing layer with an inner surface and an outer surface and a skin layer with an inner surface and an outer surface, the inner surface of the skin layer is adhered to the outer surface of the backing layer. The bottom surface of the backing layer is permanently adhered to a 4-way stretchable layer with an inner surface and an outer surface. The inner surface of the 4-way stretchable layer is releasably adhered to the railing.

As set forth above, the grip of the present invention may have tapered edges on its lengthwise sides so that when the grip is wrapped around a railing or other hand support system and the edges overlap, the thickness of the grip remains constant. As an alternative to wrapping the grip such that the edges overlap, the grip may be wrapped so that the edges do not overlap, thus providing additional friction for the user.

One method of placing the grip of the present invention on the railing comprises providing a railing and wrapping the tapered edge grip of the present invention spirally around the railing such that the tapered edges of the grip overlap. The length of the railing may be fully covered by the grip such that the thickness of the grip remains constant or, in the alternative, the edges may not overlap to provide additional friction for the user.

Another method of placing the grip of the present invention on a railing comprises providing a railing having a length and alignment targets in a parallel line along its length. Next, placing the grip so that the center lengthwise axis of the grip is centered on the axis parallel to the length of the railing. The grip of the present invention has alignment targets disposed along an axis parallel to the lengthwise edge of the grip and the grip folds around the railing such that the alignment targets of the grip align with the alignment targets of the railing and the edges of the grip abut when folded around the railing.

The grip of this invention will provide a positive gripping surface for any type of railing using any type of material as a grip and provide a safe, uniform gripping surface for the length of the railing's surface. Moreover, there is a need for a method of manufacturing for grips and a system for providing grips which are releasably adhered to a railing or hand support system. Finally, there is a need for a method of placing the grip of the present invention on to a railing or other hand support system.

### BRIEF DESCRIPTION OF THE DRAWINGS

FIG. 1 is a side view of an embodiment of the grip.

FIG. 2 is perspective view of the grip of FIG. 1.

FIG. 3 is a cross-sectional view of the grip if FIG. 2 taken along the line A-A.

FIG. 4 is a side view of another embodiment of the grip.

FIG. 5 is perspective view of the grip of FIG. 4.

FIG. 6 is a cross-sectional view of the grip if FIG. 4 taken along the line A-A.

FIGS. 7a-7c show a method or procedure for manufacture of the grip of FIG. 1.

FIGS. 8a-8e show a method or procedure for manufacture of the grip of FIG. 4.

FIG. 9 shows a method of wrapping the grip of FIG. 1.

FIG. 10 shows a method of wrapping the grip of FIG. 4.

FIG. 11 shows a method of spirally wrapping the grip of FIG. 1 or FIG. 4.

### DETAILED DESCRIPTION

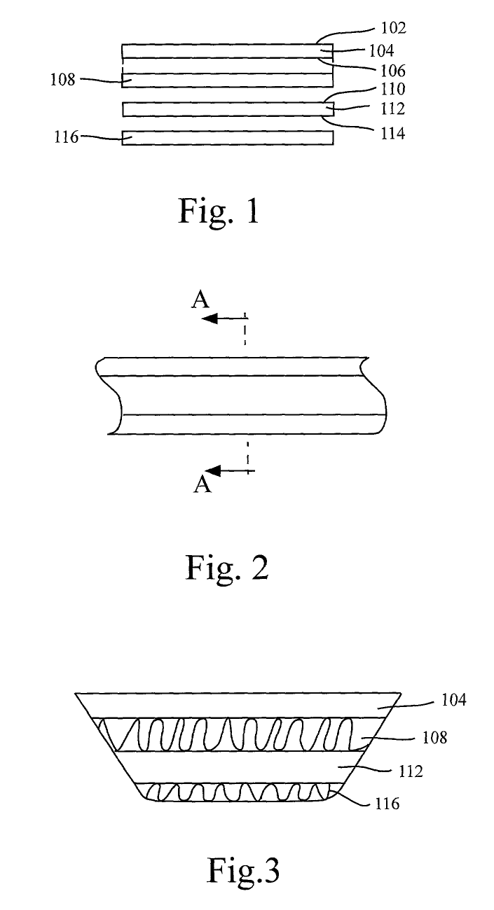

FIG. 1 discloses grip 100 for use on a railing or hand support system. Grip 100 has a skin layer 104 and a 4-way stretchable layer 112. Skin layer 104 has a top surface 102 which provides a comfortable, secure and safe gripping surface. Skin layer 104 can be formed from a variety of materials. Examples of such materials include expanded vinyl, which is vinyl with a layer of foam that imparts a soft, textured feel, leather, plastic sheeting, plastic roll stock, any type of foam product, polyurethane, urethane, woven fabrics, rubber material, foil material or any other material which could act as a covering to a hand support system. If skin layer 104 is formed from expanded vinyl, the vinyl surface may be smooth or textured. In addition, if a vinyl material is used, the vinyl may be supported or unsupported. In yet another aspect of the present invention, skin layer 104 of grip 100 of the present invention has a luminescent quality. The luminescent skin layer glows in the dark to provide additional safety in cases of an emergency. Any methods known in the art for creating luminescence may be used, for example some of the methods include transfer application processes, wet ink processes and sublimation ink processes.

Skin layer 104 has a bottom surface 106 which is affixed to the top surface 110 of 4-way stretchable material layer 112 by a permanent adhesive 108 that completely covers skin layer 104 from edge to edge. The permanent adhesive 108 can be any permanent adhesive known in the art which will permanently bond skin layer 104 to 4-way stretchable material layer 112. An example of such a permanent adhesive is Flexicon® adhesive V-402. However, it will be clear to one skilled in the art that other similar suitable adhesives may be used.

4-way stretchable layer 112 has top surface 110 and a bottom surface 114, such that top surface 110 of 4-way stretchable layer 112 conforms to and is permanently affixed to bottom surface 106 of skin layer 104. 4-way stretchable layer 112 may be comprised of any material that can simultaneously stretch in four directions such as mylar. Bottom surface 114 of 4-way stretchable layer 112 is releasably attached to the railing or hand support system by a layer of releasable adhesive 116. Releasable adhesive 116 completely covers from edge to edge and is affixed to 4-way stretchable layer 112 and provides releasable adhesion to the railing or hand support system. Releasable adhesive 116 provides secure adhesion to the railing or hand support system but may be removed with a minimal amount of effort by peeling grip 100 off the railing or hand support system. An example of a releasable adhesive is Flexicon® V-58.

In one embodiment of grip 100 disclosed in FIG. 3, the lengthwise edges of skin layer 104 and 4-way stretchable layer 112 may be tapered in thickness. FIG. 2 discloses a top view of grip 100. FIG. 3 discloses a cross sectional view of grip 100 taken from cross sectional line A to A of FIG. 2. Tapering the edges of skin layer 104 and 4-way stretchable layer 112 allows for the edges to overlap when wrapping a railing or hand support system and at the same time to maintain a constant thickness of grip 100 despite the overlapping edges. In another embodiment, the edges are tapered but wrapped in such a way that they do not overlap to provide still more friction for the user. In still another embodiment, the lengthwise edges of skin layer 104 and 4-way stretchable layer 112 are not tapered for instances when the edges do not overlap.

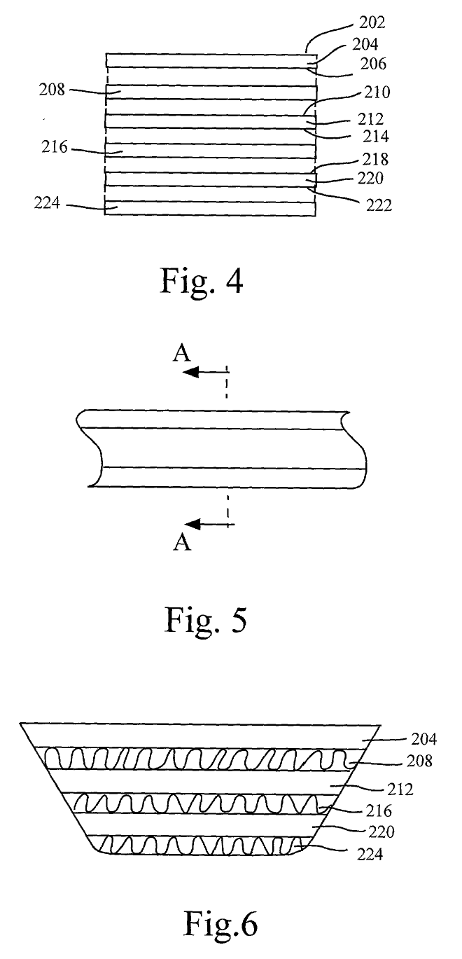

FIG. 4 discloses another embodiment of the present invention. Grip 200 has a skin layer 204, a backing layer 212 and a 4-way stretchable layer 220. Skin layer 204 has a top surface 202 which provides a comfortable, secure and safe gripping surface. Skin layer 204 can be formed from a variety of materials. Examples of such materials include, but are not limited to, expanded vinyl, which is vinyl with a layer of foam that imparts a soft, textured feel, leather, plastic sheeting, plastic roll stock, any type of foam product, polyurethane, urethane, woven fabrics, rubber material, foil material or any other material which could act as a covering to a hand support system. If skin layer 204 is formed from expanded vinyl, the vinyl surface may be smooth or textured. In addition, if a vinyl material is used, the vinyl may be supported or unsupported. In yet another aspect of the present invention, skin layer 204 of grip 200 of the present invention has a luminescent quality. The luminescent skin layer glows in the dark to provide additional safety in cases of an emergency. Any methods known in the art for creating luminescence may be used, for example some of the methods include transfer application processes, wet ink processes and sublimation ink processes.

Skin layer 204 has a bottom surface 206 which is affixed to top surface 210 of backing layer 212 by a permanent adhesive 208 which completely covers bottom surface 214 backing layer 212 from edge to edge. The permanent adhesive 208 can be any permanent adhesive known in the art which will permanently bond skin layer 204 to backing layer 212. An example of such a permanent adhesive is Flexicon® adhesive V-402. However, it will be clear to one skilled in the art that other similar suitable adhesives may be used.

Backing layer 212 has a top surface 210 and a bottom surface 214, such that top surface 210 of backing layer 212 conforms to and is affixed to bottom surface 206 of skin layer 204. Backing layer 212 may be comprised of any material suitable for providing support including open cell foam, closed cell foam, felt, paper or rubber. Bottom surface 214 of backing layer 212 is permanently adhered to the top surface 218 of 4-way stretchable material 220. The permanent adhesive attaching bottom surface 214 of backing layer 212 to top surface 218 of 4-way stretchable material 220 can be any permanent adhesive known in the art which will permanently bond the surfaces an example of which is Flexicon® V-402. 4-way stretchable material 220 has the ability to stretch in all directions simultaneously. An example of a 4-way stretchable material is Mylar. Bottom surface 222 of 4-way stretchable layer 220 is releasably attached to the railing or hand support system by releasable adhesive 224. Releasable adhesive 224 is affixed to and completely covers 4-way stretchable material 220 from edge to edge and provides releasable adhesion to the railing or hand support system. Releasable adhesive 224 provides secure adhesion to the railing or hand support system but may be removed with a minimal amount of effort by peeling grip 200 off the railing or hand support system. An example of a releasable adhesive is Flexicon® V-58.

In one embodiment of grip 200 disclosed in FIG. 4, the lengthwise edges of skin layer 204, backing layer 212 and 4-way stretchable layer 220 may be tapered in thickness. FIG. 5 discloses a top view of grip 200. FIG. 6 discloses a cross sectional view of grip 200 taken from cross sectional line A to A of FIG. 5. Tapering the edges of skin layer 204, backing layer 212 and 4-way stretchable layer 220 allows for the edges to overlap when wrapping a railing or hand support system and at the same time to maintain a constant thickness of grip 200 despite the overlapping edges. In another embodiment, the edges are tapered but wrapped in such a way that they do not overlap to provide still more friction for the user. In still another embodiment, the lengthwise edges of skin layer 204, backing layer 212 and 4-way stretchable layer 220 are not tapered for instances when the edges do not overlap but a consistent thickness of grip is desired.

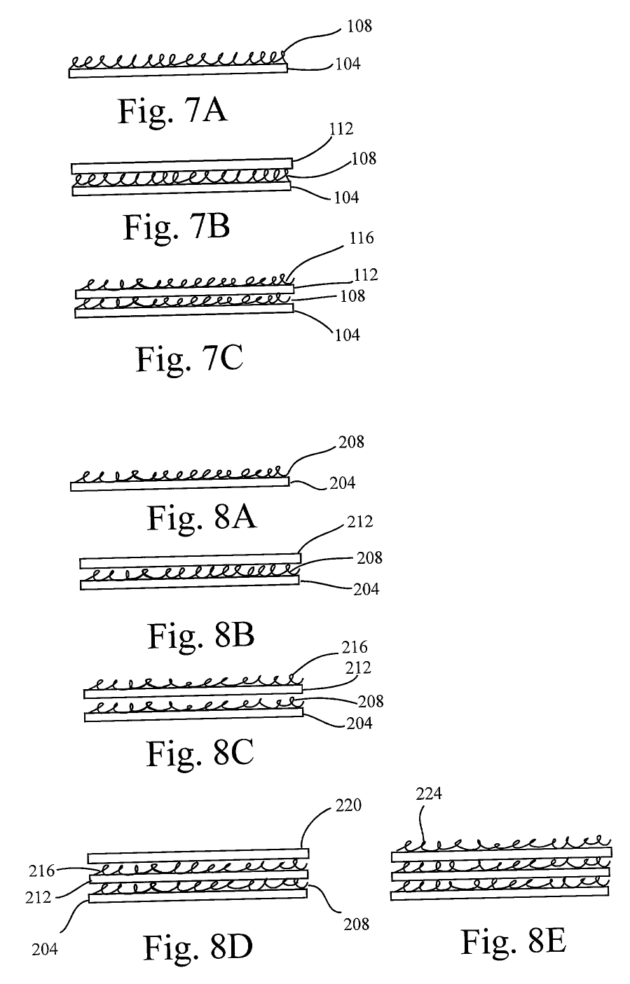

FIGS. 7a-7c disclose a method or procedure for manufacture of grip 100. For convenience, the component parts of grip 100 are numbered as in FIG. 1 designating grip 100. The method or procedure for manufacture of grip 100 begins with the act 7a of providing a skin layer 104 and applying permanent adhesive 108 to skin layer 104. Skin layer 104 can be formed from a variety of materials. Examples of such materials include expanded vinyl, which is vinyl with a layer of foam that imparts a soft, textured feel, leather, plastic sheeting, plastic roll stock, any type of foam product, polyurethane, urethane, woven fabrics, rubber material, foil material or any other material which could act as a covering to a hand support system. If skin layer 104 is formed from expanded vinyl, the vinyl surface may be smooth or rough. In addition, if a vinyl material is used, the vinyl may be supported or unsupported. Next 4-way stretchable material layer 112 is permanently adhered to skin layer 104 as disclosed in FIG. 7b. As previously set forth, 4-way stretchable layer 112 may be comprised of any material that can simultaneously stretch in four directions such as mylar. Then a releasable adhesive 116 is applied from edge to edge to 4-way stretchable material layer 112.

In one embodiment of the method of manufacture of grip 100 disclosed in FIG. 3, the lengthwise edges of skin layer 104 and 4-way stretchable layer 112 may be tapered in thickness. FIG. 2 discloses a top view of grip 100. FIG. 3 discloses a cross sectional view of grip 100 taken from cross sectional line A to A of FIG. 2. Tapering the edges of skin layer 104 and 4-way stretchable layer 112 allows for the edges to overlap when wrapping a railing or hand support system and at the same time to maintain a constant thickness of grip 100 despite the overlapping edges. In another embodiment, the edges are tapered but wrapped in such a way that they do not overlap to provide still more friction for the user. In still another embodiment, the lengthwise edges of skin layer 104 and 4-way stretchable layer 112 are not tapered for instances when the edges do not overlap.

FIGS. 8a-8e discloses a method or procedure for manufacture of grip 200. For convenience, the component parts of grip 200 are numbered as in FIG. 4 designating grip 200. The method or procedure for manufacture of grip 200 begins with the act 8a of providing a skin layer 204 and applying permanent adhesive 208 from edge to edge of skin layer 204. Skin layer 204 can be formed from a variety of materials. Examples of such materials include, but are not limited to, expanded vinyl, which is vinyl with a layer of foam that imparts a soft, textured feel, leather, plastic sheeting, plastic roll stock, any type of foam product, polyurethane, urethane, woven fabrics, rubber material, foil material or any other material which could act as a covering to a hand support system. If skin layer 204 is formed from expanded vinyl, the vinyl surface may be smooth or rough. In addition, if a vinyl material is used, the vinyl may be supported or unsupported. Next backing layer 212 is permanently adhered to skin layer 204 as disclosed in FIG. 8b. As previously set forth, backing layer 212 may be comprised of any material suitable for providing support including open cell foam, closed cell foam, felt, paper or rubber. Next, as disclosed in FIG. 8c, permanent adhesive 216 is applied to backing layer 212. Then, as shown in FIG. 8d, 4-way stretchable layer 220 is adhered to backing layer 212. Finally, as disclosed in FIG. 8e, a releasable adhesive 224 is applied from edge to edge to 4-way stretchable layer 220.

In one embodiment of the method of manufacture of grip 200 disclosed in FIG. 4, the lengthwise edges of skin layer 204, backing layer 212 and 4-way stretchable layer 220 may be tapered in thickness. FIG. S discloses a top view of grip 200. FIG. 6 discloses a cross sectional view of grip 200 taken from cross sectional line A to A of FIG. 5. Tapering the edges of skin layer 204, backing layer 212 and 4-way stretchable material layer 220 allows for the edges to overlap when wrapping a railing or hand support system with grip 200 and at the same time to maintain a constant thickness of grip 200 despite the overlapping edges. In another embodiment, the edges are tapered but wrapped in such a way that they do not overlap to provide still more friction for the user. In still another embodiment, the lengthwise edges of skin layer 204, backing layer 212 and 4-way stretchable layer 220 are not tapered for instances when the edges do not overlap.

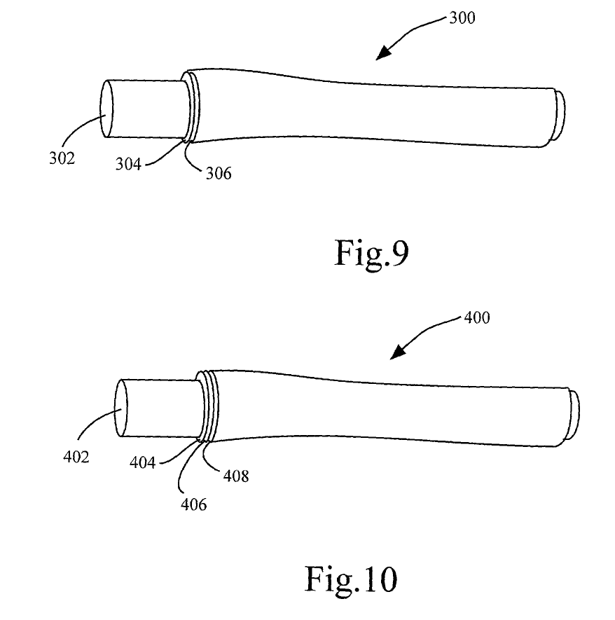

FIG. 9 discloses a system of providing a secure, safe, releasably attachable grip on a railing. The system of the present invention can be utilized with any type of railing or hand support system 302. Grip 300 of the present invention has a 4-way stretchable material layer 304 with an inner and outer surface, skin layer 306 which has an inner layer and an out layer, the inner layer of the skin layer 306 is permanently adhered to said outer surface of said 4-way stretchable material layer 304. 4-way stretchable material layer 304 is releasably adhered to railing 302.

FIG. 10 discloses another embodiment of a system of providing a secure, safe, releasably attachable grip on a railing. The system of the present invention can be utilized with any type of railing or hand support system 402. Grip 400 of the present invention has 4-way-stretchable layer 404 with an inner and outer surface, backing layer 406 with an inner and outer surface, and skin layer 408 which has an inner surface and an outer surface, the inner surface of the skin layer 408 is permanently adhered to said outer surface of said backing layer 406. The inner surface of backing layer 406 is permanently adhered to 4-way stretchable layer 404. 4-way stretchable layer 404 is releasably adhered to railing 402.

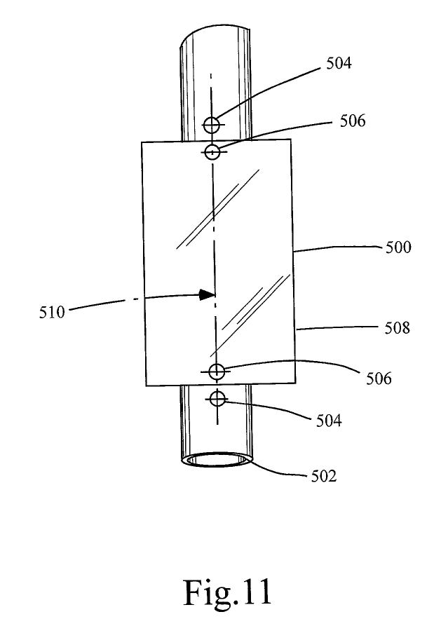

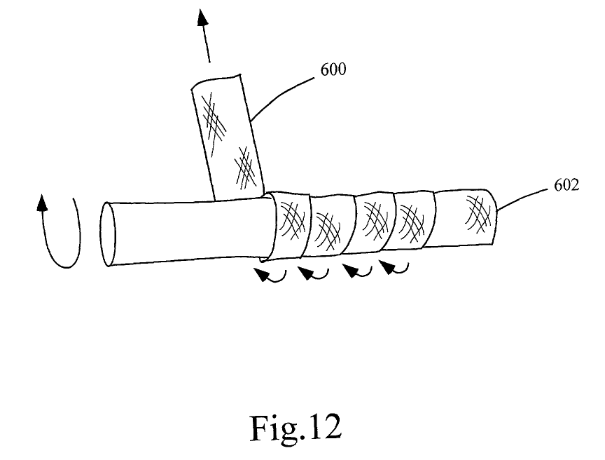

FIG. 11 discloses a method of enveloping the railing with the grip of the present invention. In one embodiment, grip 500 has alignment targets 506 along axis 510 parallel to lengthwise edge 508 of grip 500. Next, alignment targets 504 are placed on railing 502. Next, grip 500 is placed on the railing so that the center lengthwise axis of the grip is centered on the axis parallel to the length of railing 502. Next, grip 500 alignment targets 506 are aligned with railing 502 alignment targets 504. Finally, grip 500 has a width substantially similar to the circumference of railing 502 such that when grip 500 is folded around railing 502 edges 508 of grip 500 abut.

In another method of wrapping, FIG. 12 discloses a method of spirally wrapping a railing 602 with grip 600. Next, grip 600 is wrapped, placing the tapered edge of grip 600 spirally around the railing such that the tapered edges of grip 600 overlap. The length of railing 602 may be fully covered by grip 600 such that the fully covers railing 602 and the thickness of grip 600 remains constant. In an alternative embodiment, grip 600 may be wrapped around the railing so that the edges do not overlap to provide additional friction to the user.

I claim:

1. A grip comprising:
a skin layer having a top surface and a bottom surface;
a 4-way stretchable material layer with a stretchable top surface and a stretchable bottom surface, said top surface of said stretchable layer adhered permanently to said bottom surface of said skin layer; and
a releasable adhesive disposed on said bottom surface of said 4-way stretchable layer.

2. A grip as in claim 1 wherein said skin layer has a thickness of between about 6.25 millimeters and about ½ millimeter.

3. A grip as in claim 1 wherein said grip has tapered edges.

4. A grip as in claim 1 wherein said grip has alignment targets disposed along an axis parallel to its length.

5. A grip of claim 4 wherein said alignment targets are approximate to lengthwise ends of said grip.

6. A grip as in claim 1 wherein said skin layer is luminescent.

7. A grip as in claim 1 wherein said skin layer comprises expanded vinyl.

8. A grip as in claim 7 wherein said expanded vinyl has a textured surface.

9. A grip as in claim 7 wherein said expanded vinyl has a smooth surface.

10. A grip as in claim 1 wherein said skin layer is selected from the group consisting of leather, plastic sheeting, plastic roll stock, foam material, polyurethane, woven fabric, urethane, rubber and foil.

11. A grip as in claim 1 wherein said 4-way stretchable material is mylar.

12. A grip comprising:
a skin layer having a top surface and a bottom surface;
a backing layer having a top surface and a bottom surface, said top surface of said backing layer permanently adhered to said bottom surface of said skin layer;
a 4-way stretchable material layer with a stretchable top surface and a stretchable bottom surface, said top surface of said stretchable layer adhered permanently to said bottom surface of said backing layer; and
a releasably attachable adhesive permanently disposed on said bottom surface of said stretchable layer.

13. A grip as in claim 12 wherein said skin layer has a thickness of between about 6.25 millimeter s and about ½ millimeter.

14. A grip as in claim 12 wherein said grip has tapered side edges.

15. A grip as in claim 12 wherein said grip has alignment targets disposed along its length.

16. A grip of claim 15 wherein said alignment targets are approximate to lengthwise ends of said grip.

17. A grip as in claim 12 wherein said skin layer is luminescent.

18. A grip as in claim 12 wherein said skin layer comprises expanded vinyl.

19. A grip as in claim 18 wherein said expanded vinyl has a textured surface.

20. A grip as in claim 18 wherein said expanded vinyl has a smooth surface.

21. A grip as in claim 12 wherein said skin layer is selected from the group consisting of leather, plastic sheeting, plastic roll stock, foam material, polyurethane, woven fabric, urethane, rubber and foil.

22. A grip as in claim 12 wherein said backing layer material is selected from the group consisting of open cell foam, closed cell foam, elastimer rubber material, felt and paper.

23. A grip as in claim 12 wherein said 4-way stretch layer comprises mylar.

24. A method of manufacturing a safety grip comprising the steps of:
providing a skin layer having a top surface for gripping and a bottom surface;
applying a permanent adhesive to said bottom surface of said skin layer;
providing a 4-way stretchable layer having a stretchable bottom surface and a stretchable top surface, said top surface of said stretchable layer being permanently affixed to said bottom surface of said skin layer by said second permanent adhesive; and
applying a releasable adhesive to said bottom surface of said stretchable layer for releasable adhesion to a hand support system.

25. A method of manufacturing a grip as in claim 24 wherein said skin layer has a thickness of between about 6.25 millimeters and about ½ millimeter.

26. A method of manufacturing a grip as in claim 24 wherein said grip has tapered edges.

27. A method of manufacturing a safety grip as in claim 24 wherein said grip has alignment targets disposed along its length.

28. A method of manufacturing a safety grip of claim 27 wherein said alignment targets are approximate to lengthwise ends of said grip.

29. A method of manufacturing a safety grip as in claim 24 wherein said skin layer is luminescent.

30. A method of manufacturing a safety grip as in claim 24 wherein said skin layer comprises expanded vinyl.

31. A method of manufacturing a safety grip as in claim 30 wherein said expanded vinyl has a textured surface.

32. A method of manufacturing a safety grip as in claim 30 wherein said expanded vinyl has a smooth surface.

33. A method of manufacturing a safety grip as in claim 24 wherein said skin layer is selected from the group consisting of leather, plastic sheeting, plastic roll stock, foam material, polyurethane, woven fabric, urethane, rubber and foil.

34. A method of manufacturing a safety grip as in claim 24 wherein said 4-way stretchable layer comprises mylar.

35. A method of manufacturing a safety grip comprising the steps of:
providing a skin layer having a top surface for gripping and a bottom surface;
applying a permanent adhesive to said bottom surface of said skin layer;
providing a backing layer having a backing layer top surface and a backing layer bottom surface, said top surface of said backing layer affixed to said bottom surface of said skin layer by said permanent adhesive;
applying a second permanent adhesive to said bottom surface of said backing layer;
providing a 4-way stretchable layer having a stretchable bottom surface and a stretchable top surface, said top surface of said stretchable layer being permanently affixed to said bottom surface of said backing layer by said second permanent adhesive; and
applying a releasable adhesive to said bottom surface of said stretchable layer for releasable adhesion to a hand support system.

36. A method of manufacturing a grip as in claim 35 wherein said skin layer has a thickness of between about 6.25 millimeters and about ½ millimeter.

37. A method of manufacturing a grip as in claim 35 wherein said grip has tapered edges.

38. A method of manufacturing a safety grip as in claim 35 wherein said grip has alignment targets disposed along its length.

39. A method of manufacturing a safety grip of claim 38 wherein said alignment targets are approximately to lengthwise ends of said grip.

40. A method of manufacturing a safety grip as in claim 35 wherein said skin layer is luminescent.

41. A method of manufacturing a safety grip as in claim 35 wherein said skin layer comprises expanded vinyl.

42. A method of manufacturing a safety grip as in claim 41 wherein said expanded vinyl has a textured surface.

43. A method of manufacturing a safety grip as in claim 41 wherein said expanded vinyl has a smooth surface.

44. A method of manufacturing a safety grip as in claim 35 wherein said skin layer is selected from the group consisting of leather, plastic sheeting, plastic roll stock, foam material, polyurethane, woven fabric, urethane, rubber and foil.

45. A method of manufacturing a safety grip as in claim 35 wherein said backing layer material is selected from the group consisting of open cell foam, closed cell foam, elastimer rubber material, felt and paper.

46. A method of manufacturing a grip as in claim 35 wherein said 4-way stretchable layer comprises mylar.

47. A system for providing a secure, safe, releasably attachable grip on a railing comprising:
a railing having a length and cross-sectional circumference;
a 4-way stretchable layer having a inner layer and an outer layer, said inner surface of said 4-way stretchable layer releasably adhered to said railing;
a skin layer wrapped around said 4-way stretchable layer, said skin layer having an outer surface and an inner surface, said inner surface of said skin layer permanently adhered to said outer surface of said 4-way stretchable layer.

48. A system for providing a secure, safe, releasably attachable grip as in claim 47 wherein said skin layer has a thickness of between about 6.25 millimeters and about ½ millimeter.

49. A system for providing a secure, safe, releasably attachable grip as in claim 48 wherein said grip has tapered edges.

50. A system for providing a secure, safe, releasably attachable grip as in claim 48 wherein said grip has alignment targets disposed along its length.

51. A system for providing a secure, safe, releasably attachable grip of claim 48 wherein said alignment targets are approximate to lengthwise ends of said grip.

52. A system for providing a secure, safe, releasably attachable grip as in claim 48 wherein said skin layer is luminescent.

53. A system for providing a secure, safe, releasably attachable grip as in claim 48 wherein said skin layer comprises expanded vinyl.

54. A system for providing a secure, safe, releasably attachable grip as in claim 48 wherein said expanded vinyl has a textured surface.

55. A system for providing a secure, safe, releasably attachable grip as in claim 48 wherein said expanded vinyl has a smooth surface.

56. A system for providing a secure, safe, releasably attachable grip as in claim 48 wherein said skin layer is selected from the group consisting of leather, plastic sheeting, plastic roll stock, foam material, polyurethane, woven fabric, urethane, rubber and foil.

57. A system for providing a secure, safe releasably attachable grip as in claim 48 wherein said 4-way stretchable layer comprises mylar.

58. A system for providing a secure, safe, releasably attachable grip on a railing comprising:
a railing having a length and cross-sectional circumference;
a 4-way stretchable layer having a inner layer and an outer layer, said inner surface of said 4-way stretchable layer releasably adhered to said railing;
a backing layer wrapped around said 4-way stretchable layer, said backing layer having an outer surface and an inner surface, said inner surface of said backing layer permanently adhered to said outer surface of said 4-way stretchable layer;
a skin layer having an outer surface and an inner surface, said inner surface of said skin layer permanently adhered to said outer surface of said backing layer.

59. A system for providing a secure, safe, releasably attachable grip as in claim 58 wherein said skin layer has a thickness of between about 6.25 millimeters and about ½ millimeter.

60. A system for providing a secure, safe, releasably attachable grip as in claim 58 wherein said grip has tapered edges.

61. A system for providing a secure, safe, releasably attachable grip as in claim 58 wherein said grip has alignment targets disposed along its length.

62. A system for providing a secure, safe, releasably attachable grip of claim 61 wherein said alignment targets are approximate to lengthwise ends of said grip.

63. A system for providing a secure, safe, releasably attachable grip as in claim 58 wherein said skin layer is luminescent.

64. A system for providing a secure, safe, releasably attachable grip as in claim 58 wherein said skin layer comprises expanded vinyl.

65. A system for providing a secure, safe, releasably attachable grip as in claim 64 wherein said expanded vinyl has a textured surface.

66. A system for providing a secure, safe, releasably attachable grip as in claim 64 wherein said expanded vinyl has a smooth surface.

67. A system for providing a secure, safe, releasably attachable grip as in claim 58 wherein said skin layer is selected from the group consisting of leather, plastic sheeting, plastic roll stock, foam material, polyurethane, woven fabric, urethane, rubber and foil.

68. A system for providing a secure, safe, releasably attachable grip as in claim 58 wherein said backing layer material is selected from the group consisting of open cell foam, closed cell foam, elastimer rubber material, felt and paper.

69. A system for providing a secure, safe, releasably attachable grip as in claim 58 wherein said 4-way stretchable layer comprises mylar.

70. A method of wrapping the grip of claim 3 comprising:
providing a railing having a length; and
wrapping the grip of claim 3 around said railing in a spiral such that the tapered edges of the grip overlap to completely cover the length of said railing and such that said grip has a constant thickness.

71. A method of wrapping the grip of claim 5 comprising:
providing a railing having a lengthwise section and a cross-sectional circumference and having alignment targets along its length;
wrapping a grip of claim 6 such that said lengthwise edge of grip 6 is parallel to said length of said railing;
aligning said alignment targets of said railing up with said alignment targets of said grip; and
folding said grip, said grip having a width substantially similar to the circumference of said railing, such that edges of said grip abut when wrapped around said railing.

72. A method of wrapping the grip of claim 14 comprising:
providing a railing having a length; and
wrapping the grip of claim 3 around said railing in a spiral such that the tapered edges of the grip overlap to completely cover the length of said railing and such that said grip has a constant thickness.

73. A method of wrapping the grip of claim 16 comprising:
providing a railing having a lengthwise section and a cross-sectional circumference and having alignment targets along its length;
wrapping a grip of claim 6 such that said lengthwise edge of grip 6 is parallel to said length of said railing;
aligning said alignment targets of said railing up with said alignment targets of said grip; and
folding said grip, said grip having a width substantially similar to the circumference of said railing, such that edges of said grip abut when wrapped around said railing.
